SEQUENCE LISTING (24 sequences)

SEQ ID NO: 1 - DNA, 639 bp, Hepatitis B virus
  HBcAg ayw subtype nucleotide and amino acid sequence
  CDS (1)..(639)
atgcaactttttcacctctgcctaatcatctcttgttcatgtcctactgttcaagcctccaagctgtgccttgggtggctttggggcatggacatcgacccttataaagaatttggagctactgtggagttactctcgtttttgccttctgacttctttccttcagtacgagatcttctagataccgcctcagctctgtatcgggaagccttagagtctcctgagcattgttcacctcaccatactgcactcaggcaagcaattctttgctggggggaactaatgactctagctacctgggtgggtgttaatttggaagatccagcgtctagagacctagtagtcagttatgtcaacactaatatgggcctaaagttcaggcaactcttgtggtttcacatttcttgtctcacttttggaagagaaacagttatagagtatttggtgtctttcggagtgtggattcgcactcctccagcttatagaccaccaaatgcccctatcctatcaacacttccggagactactgttgttagacgacgaggcaggtcccctagaagaagaactccctcgcctcgcagacgaaggtctcaatcgccgcgtcgcagaagatctcaatctcgggaatctcaatgttag

SEQ ID NO: 2 - protein, 212 aa, Hepatitis B virus
  HBcAg ayw subtype protein sequence
MQLFHLCLIISCSCPTVQASKLCLGWLWGMDIDPYKEFGATVELLSFLPSDFFPSVRDLLDTASALYREALESPEHCSPHHTALRQAILCWGELMTLATWVGVNLEDPASRDLVVSYVNTNMGLKFRQLLWFHISCLTFGRETVIEYLVSFGVWIRTPPAYRPPNAPILSTLPETTVVRRRGRSPRRRTPSPRRRRSQSPRRRRSQSRESQC

SEQ ID NO: 3 - protein, 97 aa, Influenza A virus
  Strain A/34/PR8 M2 protein
MSLLTEVETPIRNEWGCRCNGSSDPLTIAANIIGILHLTLWILDRLFFKCIYRRFKYGLKGGPSTEGVPKSMREEYRKEQQSAVDADDGHFVSIELE

SEQ ID NO: 4 - protein, 5 aa, Artificial Sequence
  Possible linker sequence
GGGGS

SEQ ID NO: 5 - protein, 15 aa, Artificial Sequence
  Possible linker sequence
GGGGSGGGGSGGGGS

SEQ ID NO: 6 - protein, 24 aa, Artificial Sequence
  wild-type M2e sequence
MSLLTEVETPIRNEWGCRCNGSSD

SEQ ID NO: 7 - protein, 24 aa, Artificial Sequence
  M2e sequence, position 17 Cys to Ser substitution
MSLLTEVETPIRNEWGSRCNGSSD

SEQ ID NO: 8 - protein, 24 aa, Artificial Sequence
  M2e sequence, positions 17 and 19 Cys to Ser substitution
MSLLTEVETPIRNEWGSRSNGSSD

SEQ ID NO: 9 - protein, 24 aa, Artificial Sequence
  Universal M2e consensus sequence (Cys to Ser substitutions)
MSLLTEVETPTRNGWGSKSNGSSD

SEQ ID NO: 10 - protein, 24 aa, Artificial Sequence
  Variant M2e sequence
MSLLTEVETPTRNEWESRSSGSSD

SEQ ID NO: 11 - protein, 476 aa, Artificial Sequence
  Tandem core with three M2e sequences
MDIDPYKEFGATVELLSFLPSDFFPSVRDLLDTASALYREALESPEHCSPHHTALRQAILCWGELMTLATWVGNNLEGSGGGGSGGGGSGGGGSMSLLTEVETPTRNGWGSKSNGSSDMSLLTEVETPIRNEWGSRSNGSSDMSLLTEVETPTRNEWESRSSGSSDGGGGSGGGGSGGGGSGRDPASRDLVVNYVNTNMGLKIRQLLWFHISCLTFGRETVLEYLVSFGVWIRTPPAYRPPNAPILSTLPETTVVGGSSGGSGGSGGSGGSGGSGGSTMDIDPYKEFGATVELLSFLPSDFFPSVRDLLDTASALYREALESPEHCSPHHTALRQAILCWGELMTLATWVGNNLEFAGASDPASRDLVVNYVNTNMGLKIRQLLWFHISCLTFGRETVLEYLVSFGVWIRTPPAYRPPNAPILSTLPETTVVRRRDRGRSPRRRTPSPRRRRSQSPRRRRSQSRESQCLEHHHHHH

SEQ ID NO: 12 - protein, 447 aa, Artificial Sequence
  Tandem core with a HA stalk in one copy of HBcAg
MDIDPYKEFGATVELLSFLPSDFFPSVRDLLDTASALYREALESPEHCSPHHTALRQAILCWGELMTLATWVGNNLEGSMNTQFTAVGKEFNHLEKRIENLNKKVDDGFLDIWTYNAELLVLLENERTLDYHDSNVKNLYEKVRSQLKNNASGRDPASRDLVVNYVNTNMGLKIRQLLWFHISCLTFGRETVLEYLVSFGVWIRTPPAYRPPNAPILSTLPETTVVGGSSGGSGGSGGSGGSGGSGGSTMDIDPYKEFGATVELLSFLPSDFFPSVRDLLDTASALYREALESPEHCSPHHTALRQAILCWGELMTLATWVGNNLEFAGASDPASRDLVVNYVNTNMGLKIRQLLWFHISCLTFGRETVLEYLVSFGVWIRTPPAYRPPNAPILSTLPETTVVRRRDRGRSPRRRTPSPRRRRSQSPRRRRSQSRESQCLEHHHHHH

SEQ ID NO: 13 - protein, 547 aa, Artificial Sequence
  tandem core with HA stalk and three M2e sequences
MDIDPYKEFGATVELLSFLPSDFFPSVRDLLDTASALYREALESPEHCSPHHTALRQAILCWGELMTLATWVGNNLEGSMNTQFTAVGKEFNHLEKRIENLNKKVDDGFLDIWTYNAELLVLLENERTLDYHDSNVKNLYEKVRSQLKNNASGRDPASRDLVVNYVNTNMGLKIRQLLWFHISCLTFGRETVLEYLVSFGVWIRTPPAYRPPNAPILSTLPETTVVGGSSGGSGGSGGSGGSGGSGGSTMDIDPYKEFGATVELLSFLPSDFFPSVRDLLDTASALYREALESPEHCSPHHTALRQAILCWGELMTLATWVGNNLEFGGGGSGGGGSGGGGSMSLLTEVETPTRNGWGSKSNGSSDMSLLTEVETPIRNEWGSRSNGSSDMSLLTEVETPTRNEWESRSSGSSDGGGGSGGGGSGGGGSASDPASRDLVVNYVNTNMGLKIRQLLWFHISCLTFGRETVLEYLVSFGVWIRTPPAYRPPNAPILSTLPETTVVRRRDRGRSPRRRTPSPRRRRSQSPRRRRSQSRESQCLEHHHHHH

SEQ ID NO: 14 - protein, 24 aa, Artificial Sequence
  M2e sequence with OH group added at C-terminus
  MOD_RES (24)..(24): Addition of an OH group at the C-terminus
MSLLTEVETPIRNEWGCRCNGSSD

SEQ ID NO: 15 - protein, 7 aa, Artificial Sequence
  Balance alpha-helices in HBcAg
AAALAAA

SEQ ID NO: 16 - protein, 14 aa, Artificial Sequence
  Possible linker
GGGGSGGGGSGGGG

SEQ ID NO: 17 - DNA, 4807 bp, Artificial Sequence
  The DNA sequence for VLP1
agatctaacatccaaagacgaaaggttgaatgaaacctttttgccatccgacatccacaggtccattctcacacataagtgccaaacgcaacaggaggggatacactagcagcagaccgttgcaaacgcaggacctccactcctcttctcctcaacacccacttttgccatcgaaaaaccagcccagttattgggcttgattggagctcgctcattccaattccttctattaggctactaacaccatgactttattagcctgtctatcctggcccccctggcgaggttcatgtttgtttatttccgaatgcaacaagctccgcattacacccgaacatcactccagatgagggctttctgagtgtggggtcaaatagtttcatgttccccaaatggcccaaaactgacagtttaaacgctgtcttggaacctaatatgacaaaagcgtgatctcatccaagatgaactaagtttggttcgttgaaatgctaacggccagttggtcaaaaagaaacttccaaaagtcggcataccgtttgtcttgtttggtattgattgacgaatgctcaaaaataatctcattaatgcttagcgcagtctctctatcgcttctgaaccccggtgcacctgtgccgaaacgcaaatggggaaacacccgctttttggatgattatgcattgtctccacattgtatgcttccaagattctggtgggaatactgctgatagcctaacgttcatgatcaaaatttaactgttctaacccctacttgacagcaatatataaacagaaggaagctgccctgtcttaaacctttttttttatcatcattattagcttactttcataattgcgactggttccaattgacaagcttttgattttaacgacttttaacgacaacttgagaagatcaaaaaacaactaattattcgaaacgaggaattgccgtgatcactgcagaaaaaaatggacatcgacccatacaaagagttcggagctactgttgagttgttgtccttcttgccttccgacttcttcccatccgttagagacttgttggacactgcttccgctttgtacagagaagctttggaatctccagagcactgttctccacatcacactgctttgagacaggctatcttgtgttggggtgagttgatgactttggctacttgggttggtaacaatctagaaggatccatgaatacacagttcacagcagtaggtaaagagttcaaccacctggaaaaaagaatagagaatttaaataaaaaagttgatgatggtttcctggacatttggacttacaatgccgaactgttggttctattggaaaatgaaagaactttggactaccacgattcaaatgtgaagaacttatatgaaaaggtaagaagccagttaaaaaacaatgccagcggccgcgatcctgcttcaagagatttggttgttaattacgttaacactaacatgggtttgaagatcagacagttgttgtggttccacatctcctgtttgactttcggtagagagactgttttggagtacttggtttccttcggtgtttggatcagaactccaccagcttacagaccaccaaacgctccaattttgtccactttgccagagactactgttgttggtgggagctctggtggttcaggtggatcaggtggttccggtggatctggtggatcaggtgggtcgactatggatatcgatccttacaaagaatttggtgctacagttgagttgttgtcttttttgccatctgatttttttccatctgttagagatttgttggatacagcttctgctttgtatagagaggctttggagtcccctgaacactgttcacctcaccatacagctttgagacaagctattttgtgttggggagaattgatgacattggctacatgggttggaaacaacttggaattcggtggtggtggtagcggaggtggtggttctggtggtggtggttcaatgagtcttctaaccgaggtcgaaacgcctactagaaacggttgggggtccaaatccaacggttcaagtgatatgagtcttctaaccgaggtcgaaacgcctatcagaaacgaatgggggtccagatccaacggttcaagtgatatgagtcttctaaccgaggtcgaaacgcctactagaaacgaatgggaatccagatcctccggttcaagtgatggtggtggtggaagcggaggtggtggttctggtggtggtggtgctagcgatccagcttccagagacttggttgttaattatgttaacacaaatatgggattgaaaattagacagttgttgtggtttcatatttcttgtttgacatttggaagagaaacagttttggaatatttggtttcttttggagtttggattagaacacctcctgcttatagacctcctaatgctcctatcttgtctacattgcctgaaacaacagttgttagaagaagagacagaggtagatccccaagaagaagaactccatctcctagaagaagaagatcccagtcaccacgtagaagaagatcacaatccagagaatcccagtgttaaggcgcctgatgactcgagggcccaccggtcttgctagattctaatcaagaggatgtcagaatgccatttgcctgagagatgcaggcttcatttttgatacttttttatttgtaacctatatagtataggattttttttgtcattttgtttcttctcgtacgagcttgctcctgatcagcctatctcgcagctgatgaatatcttgtggtaggggtttgggaaaatcattcgagtttgatgtttttcttggtatttcccactcctcttcagagtacagaagattaagtgagaccttcgtttgtgcggatcccccacacaccatagcttcaaaatgtttctactccttttttactcttccagattttctcggactccgcgcatcgccgtaccacttcaaaacacccaagcacagcatactaaattttccctctttcttcctctagggtgtcgttaattacccgtactaaaggtttggaaaagaaaaaagagaccgcctcgtttctttttcttcgtcgaaaaaggcaataaaaatttttatcacgtttctttttcttgaaatttttttttttagtttttttctctttcagtgacctccattgatatttaagttaataaacggtcttcaatttctcaagtttcagtttcatttttcttgttctattacaactttttttacttcttgttcattagaaagaaagcatagcaatctaatctaaggggcggtgttgacaattaatcatcggcatagtatatcggcatagtataatacgacaaggtgaggaactaaaccatggccaagttgaccagtgccgttccggtgctcaccgcgcgcgacgtcgccggagcggtcgagttctggaccgaccggctcgggttctcccgggacttcgtggaggacgacttcgccggtgtggtccgggacgacgtgaccctgttcatcagcgcggtccaggaccaggtggtgccggacaacaccctggcctgggtgtgggtgcgcggcctggacgagctgtacgccgagtggtcggaggtcgtgtccacgaacttccgggacgcctccgggccggccatgaccgagatcggcgagcagccgtgggggcgggagttcgccctgcgcgacccggccggcaactgcgtgcacttcgtggccgaggagcaggactgacacgtccgacggcggcccacgggtcccaggcctcggagatccgtcccccttttcctttgtcgatatcatgtaattagttatgtcacgcttacattcacgccctccccccacatccgctctaaccgaaaaggaaggagttagacaacctgaagtctaggtccctatttatttttttatagttatgttagtattaagaacgttatttatatttcaaatttttcttttttttctgtacagacgcgtgtacgcatgtaacattatactgaaaaccttgcttgagaaggttttgggacgctcgaaggctttaatttgcaagctggagaccaacatgtgagcaaaaggccagcaaaaggccaggaaccgtaaaaaggccgcgttgctggcgtttttccataggctccgcccccctgacgagcatcacaaaaatcgacgctcaagtcagaggtggcgaaacccgacaggactataaagataccaggcgtttccccctggaagctccctcgtgcgctctcctgttccgaccctgccgcttaccggatacctgtccgcctttctcccttcgggaagcgtggcgctttctcaatgctcacgctgtaggtatctcagttcggtgtaggtcgttcgctccaagctgggctgtgtgcacgaaccccccgttcagcccgaccgctgcgccttatccggtaactatcgtcttgagtccaacccggtaagacacgacttatcgccactggcagcagccactggtaacaggattagcagagcgaggtatgtaggcggtgctacagagttcttgaagtggtggcctaactacggctacactagaaggacagtatttggtatctgcgctctgctgaagccagttaccttcggaaaaagagttggtagctcttgatccggcaaacaaaccaccgctggtagcggtggtttttttgtttgcaagcagcagattacgcgcagaaaaaaaggatctcaagaagatcctttgatcttttctacggggtctgacgctcagtggaacgaaaactcacgttaagggattttggtcatgagatc

SEQ ID NO: 18 - protein, 538 aa, Artificial Sequence
  tandem core, HA stalk, 3 copies M2e, linkers
MDIDPYKEFGATVELLSFLPSDFFPSVRDLLDTASALYREALESPEHCSPHHTALRQAILCWGELMTLATWVGNNLEGSMNTQFTAVGKEFNHLEKRIENLNKKVDDGFLDIWTYNAELLVLLENERTLDYHDSNVKNLYEKVRSQLKNNASGRDPASRDLVVNYVNTNMGLKIRQLLWFHISCLTFGRETVLEYLVSFGVWIRTPPAYRPPNAPILSTLPETTVVGGSSGGSGGSGGSGGSGGSGGSTMDIDPYKEFGATVELLSFLPSDFFPSVRDLLDTASALYREALESPEHCSPHHTALRQAILCWGELMTLATWVGNNLEFGGGGSGGGGSGGGGSMSLLTEVETPTRNGWGSKSNGSSDMSLLTEVETPIRNEWGSRSNGSSDMSLLTEVETPTRNEWESRSSGSSDGGGGSGGGGSGGGGASDPASRDLVVNYVNTNMGLKIRQLLWFHISCLTFGRETVLEYLVSFGVWIRTPPAYRPPNAPILSTLPETTVVRRRDRGRSPRRRTPSPRRRRSQSPRRRRSQSRESQC

SEQ ID NO: 19 - DNA, 4495 bp, Artificial Sequence
  The DNA sequence for VLP2
agatctaacatccaaagacgaaaggttgaatgaaacctttttgccatccgacatccacaggtccattctcacacataagtgccaaacgcaacaggaggggatacactagcagcagaccgttgcaaacgcaggacctccactcctcttctcctcaacacccacttttgccatcgaaaaaccagcccagttattgggcttgattggagctcgctcattccaattccttctattaggctactaacaccatgactttattagcctgtctatcctggcccccctggcgaggttcatgtttgtttatttccgaatgcaacaagctccgcattacacccgaacatcactccagatgagggctttctgagtgtggggtcaaatagtttcatgttccccaaatggcccaaaactgacagtttaaacgctgtcttggaacctaatatgacaaaagcgtgatctcatccaagatgaactaagtttggttcgttgaaatgctaacggccagttggtcaaaaagaaacttccaaaagtcggcataccgtttgtcttgtttggtattgattgacgaatgctcaaaaataatctcattaatgcttagcgcagtctctctatcgcttctgaaccccggtgcacctgtgccgaaacgcaaatggggaaacacccgctttttggatgattatgcattgtctccacattgtatgcttccaagattctggtgggaatactgctgatagcctaacgttcatgatcaaaatttaactgttctaacccctacttgacagcaatatataaacagaaggaagctgccctgtcttaaacctttttttttatcatcattattagcttactttcataattgcgactggttccaattgacaagcttttgattttaacgacttttaacgacaacttgagaagatcaaaaaacaactaattattcgaaacgaggaattgccgtgatcactgcagaaaaaaatggacatcgacccatacaaagagttcggagctactgttgagttgttgtccttcttgccttccgacttcttcccatccgttagagacttgttggacactgcttccgctttgtacagagaagctttggaatctccagagcactgttctccacatcacactgctttgagacaggctatcttgtgttggggtgagttgatgactttggctacttgggttggtaacaatctagaaggatccagaatccaagatttggaaaagtacgttgaagatactaagattgatttgtggtcttacaacgctgaattgttggttgctttggaaaaccaacatactattgatttgactgattctgaaatgaacaagttgtttgaaaagactagaagacaattgagagaaaacgctagcggccgcgatcctgcttcaagagatttggttgttaattacgttaacactaacatgggtttgaagatcagacagttgttgtggttccacatctcctgtttgactttcggtagagagactgttttggagtacttggtttccttcggtgtttggatcagaactccaccagcttacagaccaccaaacgctccaattttgtccactttgccagagactactgttgttggtgggagctctggtggttcaggtggatcaggtggttccggtggatctggtggatcaggtgggtcgactatggatatcgatccttacaaagaatttggtgctacagttgagttgttgtcttttttgccatctgatttttttccatctgttagagatttgttggatacagcttctgctttgtatagagaggctttggagtcccctgaacactgttcacctcaccatacagctttgagacaagctattttgtgttggggagaattgatgacattggctacatgggttggaaacaacttggaattcggttccggatcaggtggtggaaagggtggtggatcaggttctgctagcgatccagcttccagagacttggttgttaattatgttaacacaaatatgggattgaaaattagacagttgttgtggtttcatatttcttgtttgacatttggaagagaaacagttttggaatatttggtttcttttggagtttggattagaacacctcctgcttatagacctcctaatgctcctatcttgtctacattgcctgaaacaacagttgttagaagaagagacagaggtagatccccaagaagaagaactccatctcctagaagaagaagatcccagtcaccacgtagaagaagatcacaatccagagaatcccagtgttaaggcgcctgatgactcgagggcccaccggtcttgctagattctaatcaagaggatgtcagaatgccatttgcctgagagatgcaggcttcatttttgatacttttttatttgtaacctatatagtataggattttttttgtcattttgtttcttctcgtacgagcttgctcctgatcagcctatctcgcagctgatgaatatcttgtggtaggggtttgggaaaatcattcgagtttgatgtttttcttggtatttcccactcctcttcagagtacagaagattaagtgagaccttcgtttgtgcggatcccccacacaccatagcttcaaaatgtttctactccttttttactcttccagattttctcggactccgcgcatcgccgtaccacttcaaaacacccaagcacagcatactaaattttccctctttcttcctctagggtgtcgttaattacccgtactaaaggtttggaaaagaaaaaagagaccgcctcgtttctttttcttcgtcgaaaaaggcaataaaaatttttatcacgtttctttttcttgaaatttttttttttagtttttttctctttcagtgacctccattgatatttaagttaataaacggtcttcaatttctcaagtttcagtttcatttttcttgttctattacaactttttttacttcttgttcattagaaagaaagcatagcaatctaatctaaggggcggtgttgacaattaatcatcggcatagtatatcggcatagtataatacgacaaggtgaggaactaaaccatggccaagttgaccagtgccgttccggtgctcaccgcgcgcgacgtcgccggagcggtcgagttctggaccgaccggctcgggttctcccgggacttcgtggaggacgacttcgccggtgtggtccgggacgacgtgaccctgttcatcagcgcggtccaggaccaggtggtgccggacaacaccctggcctgggtgtgggtgcgcggcctggacgagctgtacgccgagtggtcggaggtcgtgtccacgaacttccgggacgcctccgggccggccatgaccgagatcggcgagcagccgtgggggcgggagttcgccctgcgcgacccggccggcaactgcgtgcacttcgtggccgaggagcaggactgacacgtccgacggcggcccacgggtcccaggcctcggagatccgtcccccttttcctttgtcgatatcatgtaattagttatgtcacgcttacattcacgccctccccccacatccgctctaaccgaaaaggaaggagttagacaacctgaagtctaggtccctatttatttttttatagttatgttagtattaagaacgttatttatatttcaaatttttcttttttttctgtacagacgcgtgtacgcatgtaacattatactgaaaaccttgcttgagaaggttttgggacgctcgaaggctttaatttgcaagctggagaccaacatgtgagcaaaaggccagcaaaaggccaggaaccgtaaaaaggccgcgttgctggcgtttttccataggctccgcccccctgacgagcatcacaaaaatcgacgctcaagtcagaggtggcgaaacccgacaggactataaagataccaggcgtttccccctggaagctccctcgtgcgctctcctgttccgaccctgccgcttaccggatacctgtccgcctttctcccttcgggaagcgtggcgctttctcaatgctcacgctgtaggtatctcagttcggtgtaggtcgttcgctccaagctgggctgtgtgcacgaaccccccgttcagcccgaccgctgcgccttatccggtaactatcgtcttgagtccaacccggtaagacacgacttatcgccactggcagcagccactggtaacaggattagcagagcgaggtatgtaggcggtgctacagagttcttgaagtggtggcctaactacggctacactagaaggacagtatttggtatctgcgctctgctgaagccagttaccttcggaaaaagagttggtagctcttgatccggcaaacaaaccaccgctggtagcggtggtttttttgtttgcaagcagcagattacgcgcagaaaaaaaggatctcaagaagatcctttgatcttttctacggggtctgacgctcagtggaacgaaaactcacgttaagggattttggtcatgagatc

SEQ ID NO: 20 - protein, 434 aa, Artificial Sequence
  tandem core, HA stalk, null insert
MDIDPYKEFGATVELLSFLPSDFFPSVRDLLDTASALYREALESPEHCSPHHTALRQAILCWGELMTLATWVGNNLEGSRIQDLEKYVEDTKIDLWSYNAELLVALENQHTIDLTDSEMNKLFEKTRRQLRENASGRDPASRDLVVNYVNTNMGLKIRQLLWFHISCLTFGRETVLEYLVSFGVWIRTPPAYRPPNAPILSTLPETTVVGGSSGGSGGSGGSGGSGGSGGSTMDIDPYKEFGATVELLSFLPSDFFPSVRDLLDTASALYREALESPEHCSPHHTALRQAILCWGELMTLATWVGNNLEFGSGSGGGKGGGSGSASDPASRDLVVNYVNTNMGLKIRQLLWFHISCLTFGRETVLEYLVSFGVWIRTPPAYRPPNAPILSTLPETTVVRRRDRGRSPRRRTPSPRRRRSQSPRRRRSQSRESQC

SEQ ID NO: 21 - protein, 14 aa, Artificial Sequence
  Null insert
GSGSGGGKGGGSGS

SEQ ID NO: 22 - protein, 72 aa, Artificial Sequence
  HA Stalk 403-474 (from H1N1)
MNTQFTAVGKEFNHLEKRIENLNKKVDDGFLDIWTYNAELLVLLENERTLDYHDSNVKNLYEKVRSQLKNNA

SEQ ID NO: 23 - protein, 55 aa, Artificial Sequence
  HA long alpha helix (LAH) 420-474 (from H1N1)
RIENLNKKVDDGFLDIWTYNAELLVLLENERTLDYHDSNVKNLYEKVRSQLKNNA

SEQ ID NO: 24 - protein, 55 aa, Artificial Sequence
  HA long alpha helix (LAH) 421-475 (from H3N2)
RIQDLEKYVEDTKIDLWSYNAELLVALENQHTIDLTDSEMNKLFEKTRRQLRENA

(19) United States
(12) Patent Application Publication
(10) Pub. No.: US 2018/0034051 A1
(43) Pub. Date: Feb. 1, 2018

(54) VACCINES BASED ON HEPATITIS B CORE ANTIGENS

(71) Applicant: IQUR LIMITED, London (GB)

(72) Inventors: Michael Anthony WHELAN, London (GB); Alejandro RAMIREZ CEBALLOS, London (GB); Vincenzo CRESCENTE, London (GB)

(21) Appl. No.: 15/532,466

(22) PCT Filed: Dec. 3, 2015
(86) PCT No.: PCT/GB2015/053699

§ 371 Date: Jun. 1, 2017

(30) Foreign Application Priority Data
Dec. 5, 2014 (GB) 1421692.3

(51) Int. Cl. H01M 4/505; H01M 4/525; H01M 4/62; H01M 10/0525

(52) U.S. Cl. CPC H01M 4/505; H01M 10/0525; H01M 4/525; H01M 4/625

(57) ABSTRACT

The present invention relates to an electrode composition, to the use of the electrode composition as a cathode and to a lithium-ion cell or battery comprising the electrode composition as a cathode. An electrode composition comprising: a lithium intercalated transition metal oxide or composite thereof in an amount in excess of 80 wt %; an electrochemically exfoliated graphene material; and conductive carbon, wherein the combined amount of electrochemically exfoliated graphene material and conductive carbon is in the range 5 to 11 wt % and the weight ratio of electrochemically exfoliated graphene material:conductive carbon is in the range 90:10 to 10:90.

The present invention relates to an electrode composition, to the use of the electrode composition as a cathode and to a lithium-ion cell or battery comprising the electrode composition as a cathode.

The use of lithium-ion batteries is increasingly common in consumer electronics and industrially in (for example) military, automotive and aerospace applications. Lithium-ion batteries are rechargeable with a high energy density, no memory effect and only a slow discharge when not in use. The performance of cathode materials in lithium-ion batteries is the focus of intensive research but improvements in performance are sought after.

The present invention is based on the recognition that the capacity and power of lithium intercalated transition metal oxide can be increased in the presence of judicious proportions of an electrochemically exfoliated graphene material and conductive carbon.

Thus viewed from one aspect the present invention provides an electrode composition comprising:
a lithium intercalated transition metal oxide or composite thereof in an amount in excess of 80 wt %;
an electrochemically exfoliated graphene material; and
conductive carbon,
   wherein the combined amount of electrochemically exfoliated graphene material and conductive carbon is in the range 5 to 11 wt % and the weight ratio of electrochemically exfoliated graphene material:conductive carbon is in the range 90:10 to 10:90.

Preferably the weight ratio of electrochemically exfoliated graphene material:conductive carbon is in the range 85:15 to 15:85, particularly preferably in the range 75:25 to 25:75, more preferably in the range 60:40 to 40:60, most preferably in the range 55:45 to 45:55 (eg about 50:50).

Preferably the combined amount of electrochemically exfoliated graphene material and conductive carbon is in the range 6 to 10 wt %, particularly preferably in the range 7 to 9 wt % (eg about 8 wt %).

The amount of conductive carbon may be 6 wt % or less.

The particle morphology of the electrochemically exfoliated graphene material may be flake (eg nanoflake), platelet (eg nanoplatelet) or a mixture thereof.

Preferably the particle morphology of the electrochemically exfoliated graphene material is flake.

The mean lateral dimension of the flake may be in excess of 1 μm (as measured by SEM). The mean lateral dimension of the flake may be less than 50 μm (as measured by SEM). Preferably the mean lateral dimension of the flake is in the range 3 to 10 μm (as measured by SEM).

The mean thickness of the flake may be 200 nm or less (as measured by SEM).

The mean thickness of platelets may be 100 nm or less, preferably 15 nm or less (as measured by SEM). The mean diameter (eg volume, number or surface mean diameter) of the platelets may be 100 μm or less. The platelets may be graphite nanoplatelets.

In an embodiment, the electrochemically exfoliated graphene material comprises (eg consists essentially of or is) monolayer graphene, multi-layer graphene (eg few-layer graphene such as bilayer or trilayer graphene) or a laminate or stack thereof.

In a preferred embodiment, the electrochemically exfoliated graphene material comprises multi-layer graphene.

The electrochemically exfoliated graphene material may comprise 25 wt % or more of multi-layer graphene, preferably 50 wt % or more of multi-layer graphene, particularly preferably 75 wt % or more of multi-layer graphene, more preferably 90 wt % or more of multi-layer graphene.

In a preferred embodiment, the electrochemically exfoliated graphene material is substantially multi-layer graphene.

The electrochemically exfoliated graphene material may be a plurality of graphene particles (eg flakes and/or platelets) or domains (eg crystallites) of variable thickness.

The thickness distribution of the graphene particles or domains may be such that at least 25 wt % (preferably 50 wt %, particularly preferably 75 wt %, more preferably 90 wt %) of the electrochemically exfoliated graphene material has a thickness of 1 to 15 graphene layers, preferably 1 to 10 graphene layers, particularly preferably 1 to 9 graphene layers (as measured by RAMAN spectroscopy).

In a preferred embodiment, at least 90 wt % of the electrochemically exfoliated graphene material has a thickness of 1 to 9 graphene layers (as measured by RAMAN spectroscopy).

The mean thickness of the graphene particles or domains may be in the range 1 to 9 graphene layers, preferably in the range 2 to 7 graphene layers, particularly preferably in the range 2 to 5 graphene layers (as measured by RAMAN spectroscopy).

The surface oxygen content of the electrochemically exfoliated graphene material may be less than 10 at %, preferably less than 7 at %, particularly preferably less than 5 at %. The amount of graphene oxide may be less than 1 wt %. Preferably the electrochemically exfoliated graphene material is substantially free of oxygen.

The electrochemically exfoliated graphene material may be substantially non-functionalised.

The electrochemically exfoliated graphene material may be substantially pristine graphene.

Typically the electrochemically exfoliated graphene material is obtainable electrochemically from exfoliable graphite material (eg natural or synthetic graphite such as highly ordered pyrolytic graphite, graphite oxide or graphene oxide). The exfoliable graphite material may have any convenient morphology (eg fibre or rod) or form (eg mineral or powder).

The electrochemically exfoliated graphene material may be prepared according to procedures disclosed in WO-A-2013/132261, WO-A-2012/120264 or WO-A-2013/114116.

The conductive carbon may be carbon black such as acetylene black, channel black, furnace black, lamp black or thermal black.

The conductive carbon may be graphite. The graphite may have a mean lateral dimension in the range 6 to 150 μm (as measured by SEM).

The amount of lithium intercalated transition metal oxide or composite thereof is preferably 82 wt % or more, particularly preferably 84 wt % or more, more preferably 88 wt % or more, yet more preferably 90 wt % or more, most preferably 92 wt % or more.

Preferably the amount of lithium intercalated transition metal oxide or composite thereof is in the range 84 to 92 wt %, particularly preferably 84 to 88 wt %.

The lithium intercalated transition metal oxide may be a layered oxide (eg O3 type layered oxide) or spinel.

Preferably the lithium intercalated transition metal oxide or composite thereof has the empirical (compositional) formula unit Li(LiₓM₁₋ₓO₂)ₙ, wherein M is one or more (eg one, two or three) of the first row transition metals, n is 1 or 2 and 0 x 1/3. Particularly preferably the lithium intercalated transition metal oxide or composite thereof has an empirical formula unit Li(LiₓM₁₋ₓO₂).

In a first preferred embodiment, 0<x≦⅓. Such overlithiated (lithium rich) materials display improved long term cycling due to a more stable LiMO₂ structure.

The lithium intercalated transition metal oxide may be Li (Li_{1/3-2y/3}Ni_{y}Mn_{2y-y/3}O)₂ (wherein 0<y<0.5).

A preferred lithium intercalated transition metal oxide or composite thereof has an empirical formula unit Li(Liₓ(Ni_{1/3}Mn_{1/3}Co_{1/3})₁₋ₓ)O₂.

In a second preferred embodiment, x is zero.

Preferably M is one or more (eg a pair) of Ti, Cr, Fe, Co, Ni, Mn, V and Cu. Particularly preferably M is one or more (eg a pair) of Co, Ni and Mn.

For example, M is Ni and Mn.

For example, M is Co and Mn.

For example, M is Ni and Co.

For example, M is Ni, Mn and Co.

In a preferred embodiment, the lithium intercalated transition metal oxide is of chemical formula

Li(NiₐMn_{b}Co_{1-a-b})O₂

wherein 0≦a≦1 and 0≦b≦1.

Typically a and b are the same. For example, a and b may be zero. Alternatively a and b may be 0.5.

Preferably 0<a≦1. Preferably 0<b≦1.

Preferably 0≦a≦0.8. Particularly preferably 0<a≦0.8.

Preferably 0≦b≦0.8. Particularly preferably 0<b≦0.8.

Preferably 0≦a≦0.4. Particularly preferably 0<a≦0.4.

Preferably 0≦b≦0.4. Particularly preferably 0<b≦0.4.

Preferably the lithium intercalated transition metal oxide is LiNi_{1/3}Mn_{1/3}CO_{1/3}O₂.

The lithium intercalated transition metal oxide may be a solid solution (eg a binary or ternary solid solution). For example, the solid solution may be a solid solution of at least two (preferably all) of LiMnO₂, LiCoO₂ and LiNiO₂.

The composite (eg nanocomposite) of the lithium intercalated transition metal oxide may be a binary or ternary phase composite. The composite may consist essentially of the lithium intercalated transition metal oxide.

The composite of the lithium intercalated transition metal oxide may be an overlithiated (lithium-rich) composite. The overlithiated composite typically includes a lithium manganese oxide (eg Li₂MnO₃). For example, the lithium intercalated transition metal oxide may be Li(Ni_{1/3}Mn1/3Co_{1/3})O₂ in an overlithiated composite with Li₂MnO₃.

In the embodiments described hereinbefore, each first row transition metal M is optionally partially substituted by a metal dopant. The metal dopant for each partial substitution may be the same or different. The charge on the metal dopant is typically the same as the charge on the first row transition metal M which it substitutes. The (or each) metal dopant may be present in the substitution in an amount up to 10 at %, preferably up to 7 at %, more preferably up to 5 at %, most preferably up to 1 at %. The metal dopant may be selected from the group consisting of Mg, Al, Zn, a first row transition metal and a rare earth metal (eg a lanthanide).

The lithium intercalated transition metal oxide or composite thereof may be may be prepared by a solid-state reaction of constituent metals in compound form (eg metal oxides, hydroxides, nitrates or carbonates) or of metal precursors formed by wet chemistry (eg sol-gel synthesis or metal co-precipitation). The lithium intercalated transition metal oxide or composite thereof may be prepared by hydrothermal synthesis, combustion, freeze drying, aerosol techniques or spray drying.

Preferably the lithium intercalated transition metal oxide or composite thereof is obtainable by sol-gel synthesis.

The particle morphology of the lithium intercalated transition metal oxide may be spherical, rod (eg nanorod), wire (eg nanowire), fibre (eg nanofibre) or tube (eg nanotube).

The mean diameter (eg volume, number or surface mean diameter) of the particles of lithium intercalated transition metal oxide or composite thereof may be up to 50 μm. The mean diameter (eg volume, number or surface mean diameter) of the particles of lithium intercalated transition metal oxide or composite thereof may be greater than 50 μm. The mean diameter (eg volume, number or surface mean diameter) of the particles of lithium intercalated transition metal oxide or composite thereof may be less than 5 μm.

Preferably the mean diameter (eg volume, number or surface mean diameter) of the particles of lithium intercalated transition metal oxide is 1 μm or less. Particularly preferably the mean diameter (eg volume, number or surface mean diameter) of the particles of lithium intercalated transition metal oxide is in the range 0.2 to 1 μm.

In a preferred embodiment, the amount of lithium intercalated transition metal oxide or composite thereof is 84 wt % or more, the weight ratio of electrochemically exfoliated graphene material:conductive carbon is in the range 75:25 to 25:75, the particle morphology of the electrochemically exfoliated graphene material is flake and the mean lateral dimension of the flake is in the range 3 to 10 μm (as measured by SEM) and the mean diameter (eg volume, number or surface mean diameter) of the particles of lithium intercalated transition metal oxide is 1 μm or less.

Without wishing to be bound by theory, the relative amounts and sizes of the components of the cathode composition in this embodiment appear to give optimum connectivity and conductivity leading to a superior performance.

The electrode composition may further comprise a binder. The binder is typically a conducting polymer such as polytetrafluoroethylene (PTFE), polyvinylidene fluoride (PVDF), poly(vinylidene fluoride-hexafluoropropylene) copolymer (PVDF:HFP), ethylene-propylene-diene copolymer (EPDM) or styrene-butadiene rubber (SBR). The amount of binder may be 10 wt % or less, preferably 7 wt % or less, more preferably 5 wt % or less.

Viewed from a further aspect the present invention provides the use of an electrode composition as hereinbefore defined as a cathode.

For the purposes of the use according to the invention, the electrode composition may be in any self-supporting form. This may be facilitated by the incorporation of a binder.

Viewed from a yet still further aspect the present invention provides a lithium-ion cell or battery comprising an electrode composition as hereinbefore defined as a cathode, an anode and a lithium-ion conducting electrolyte.

The lithium-ion conducting electrolyte is typically a lithium salt (eg a non-coordinating anionic salt such as lithium perchlorate, lithium hexafluorophosphate, lithium borofluoride, lithium hexafluoroarsenide, lithium trifluoro-metasulfonate and bis-trifluoromethyl sulfonylimide lithium) in an organic solvent (eg organic carbonate). The anode may be carbon (eg natural or synthetic graphite, amorphous carbon or graphitised carbon) or lithium metal. Typically the lithium-ion cell or battery further comprises a separator.

The present invention will now be described in a non-limitative sense with reference to Examples and Figures in which:

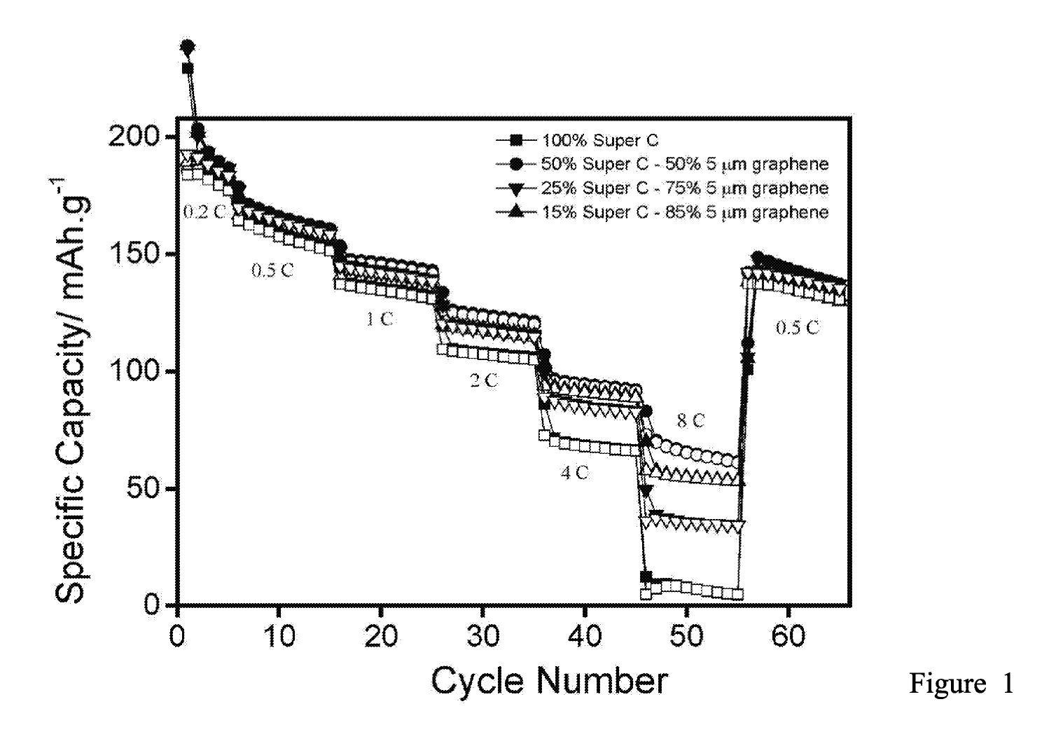

FIG. 1: Cyclability plot showing the rate capability of LiNMC cathode compositions with different weight ratios of Super C carbon black: graphene at charge rates of 0.2 C, 0.5 C, 1 C, 2 C, 4 C, 8 C and 0.5 C (filled symbols represent the charge capacity and unfilled symbols represent the discharge capacity);

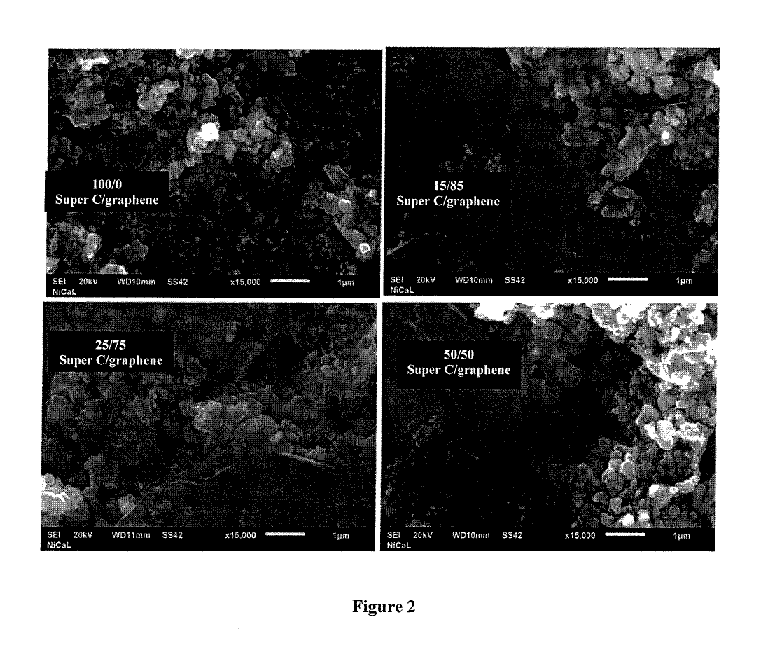

FIG. 2: SEM of the different LiNMC cathode compositions;

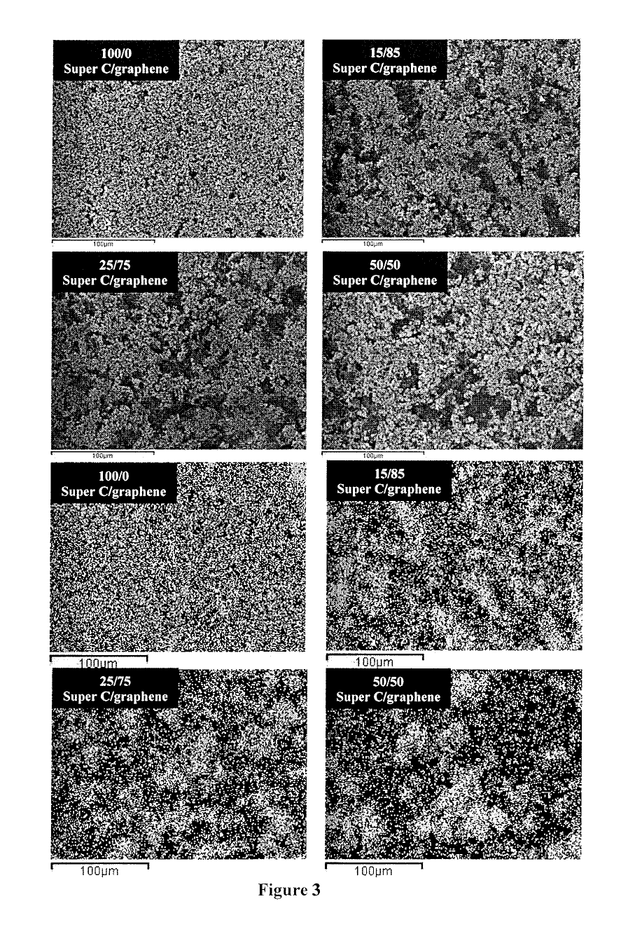

FIG. 3: SEM and EDS of the different LiNMC cathode compositions;

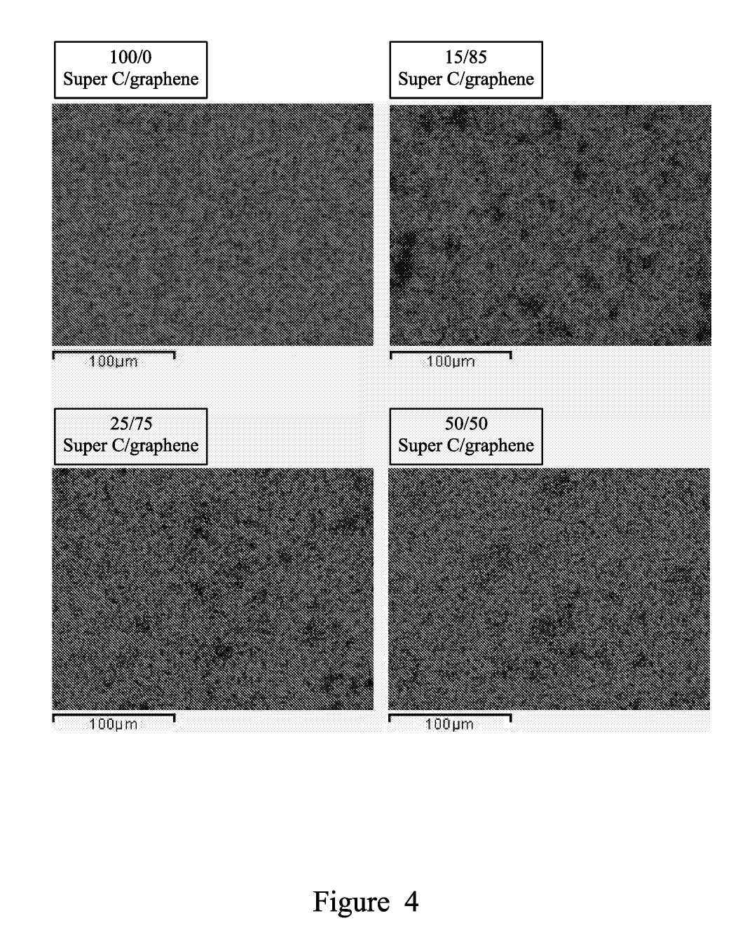

FIG. 4: EDS elemental mapping for manganese from the different LiNMC cathode compositions;

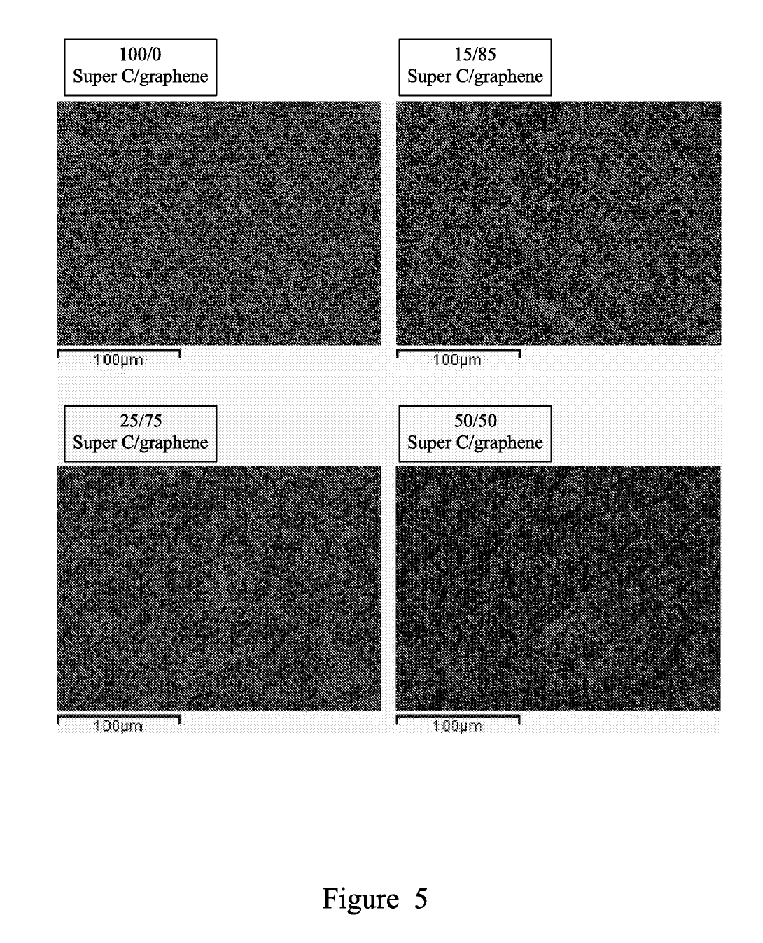

FIG. 5: EDS elemental mapping for fluorine from the different LiNMC cathode compositions;

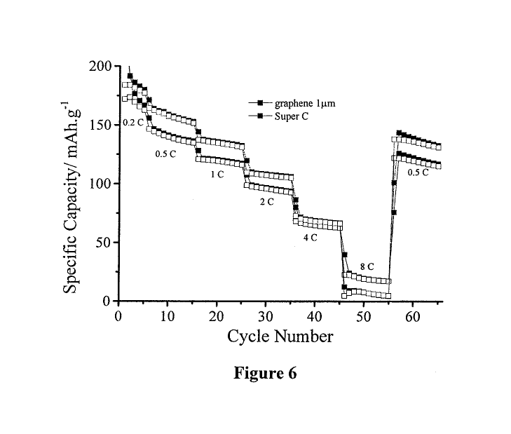

FIG. 6: Waterfall plots for LiNMC cathode compositions with 100% 1 μm graphene flake and 100% Super C carbon black at charge rates of 0.2 C, 0.5 C, 1 C, 2 C, 4 C, 8 C and 0.5 C;

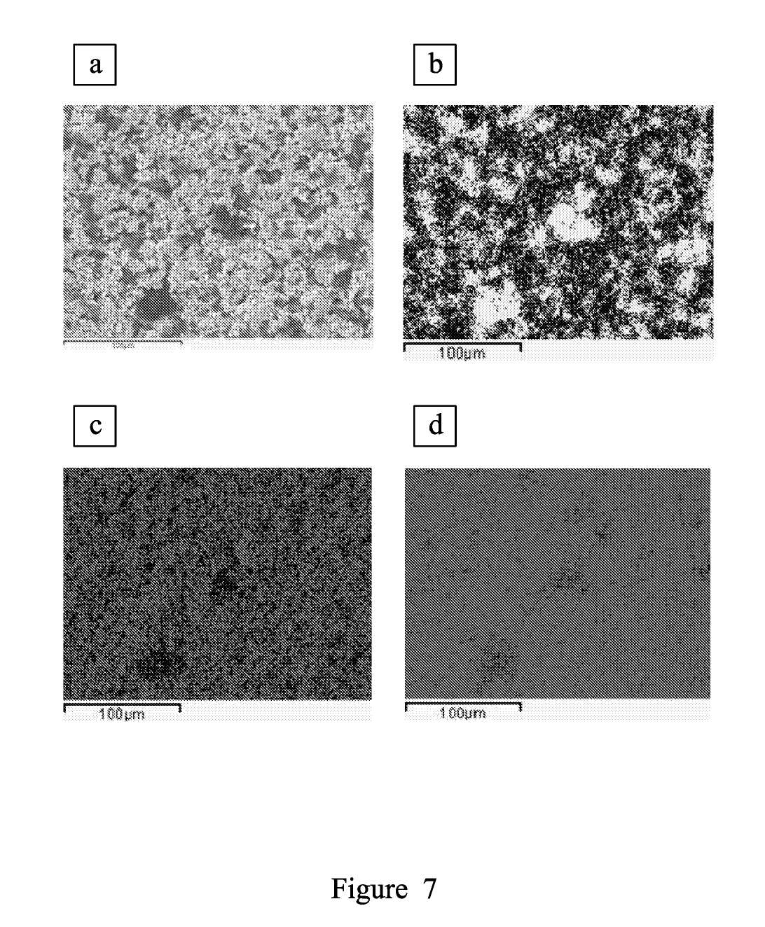

FIG. 7: (a) SEM image of LiNMC cathode compositions with 100% 1 μm graphene flake and EDS elemental mapping of (b) carbon, (c) fluorine and (d) manganese;

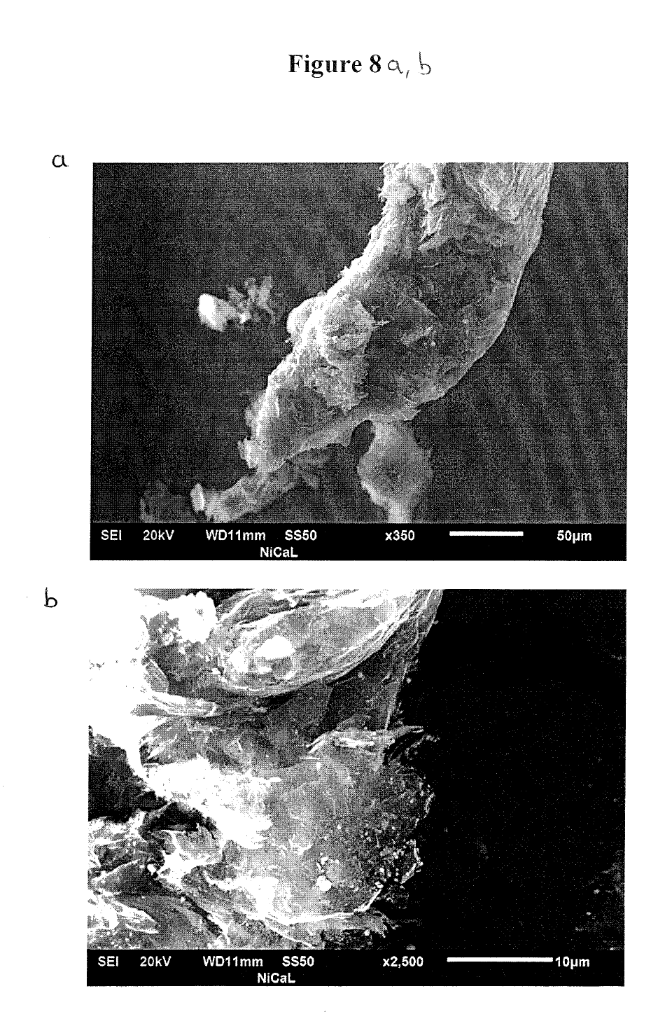

FIG. 8: SEM image of the LiNMC cathode composition with 5 μm graphene;

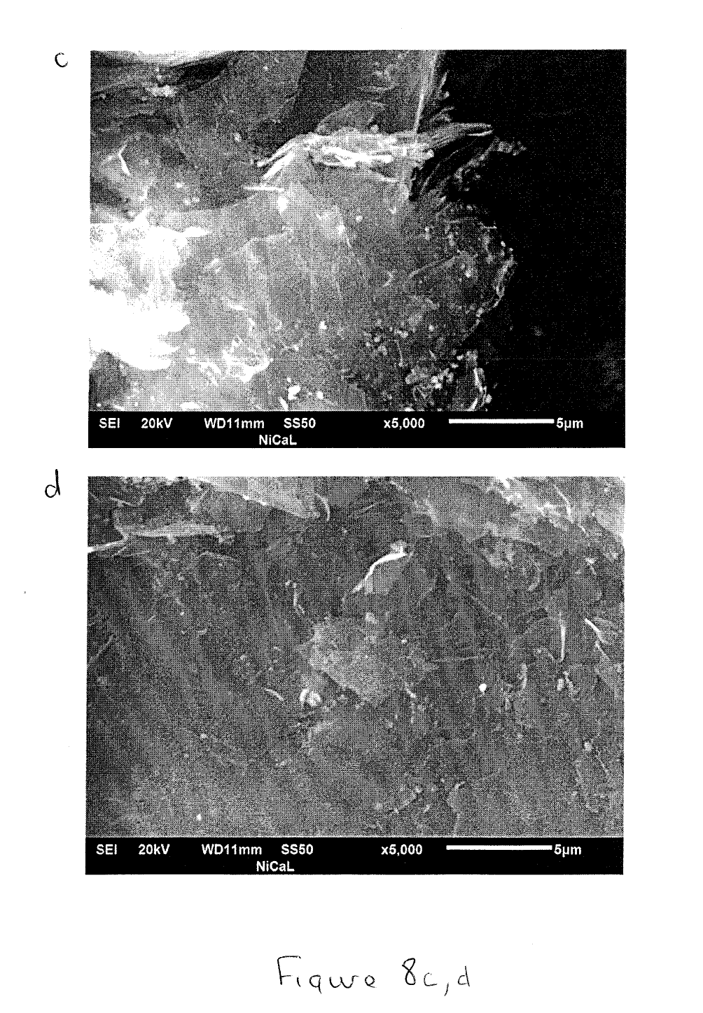

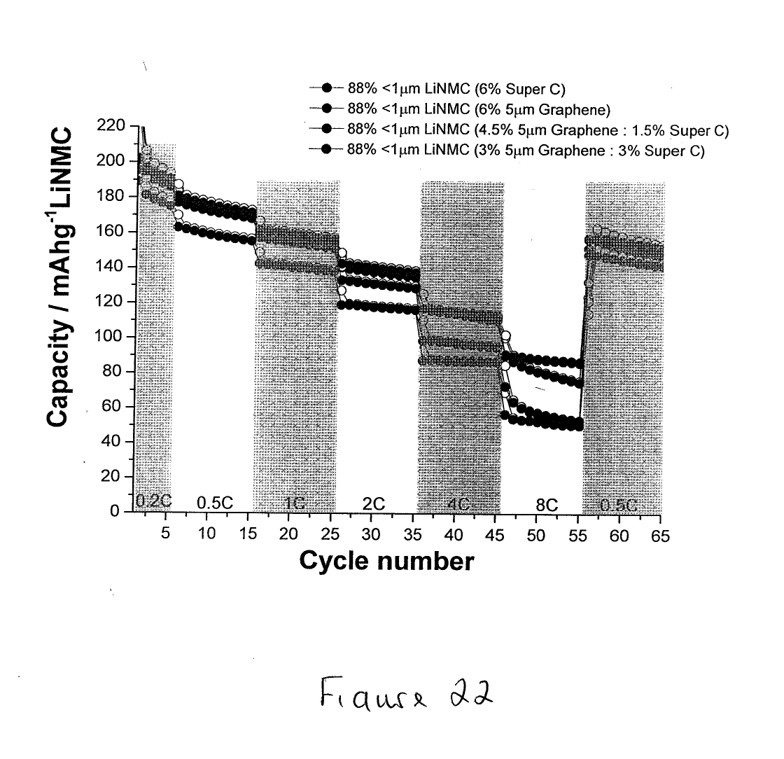

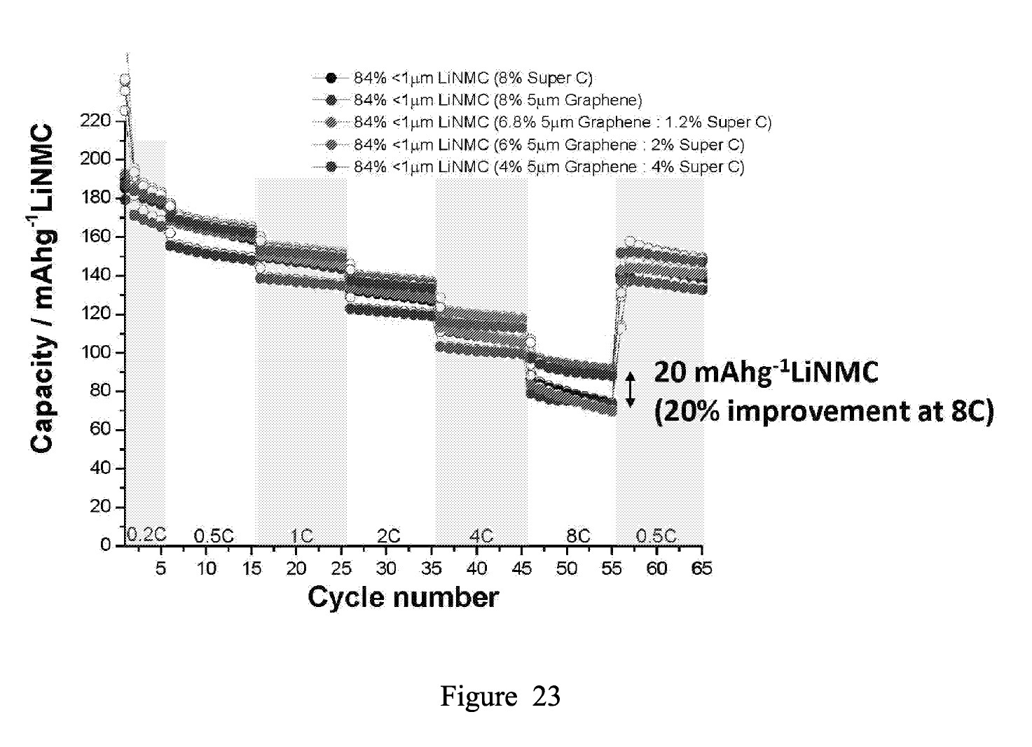

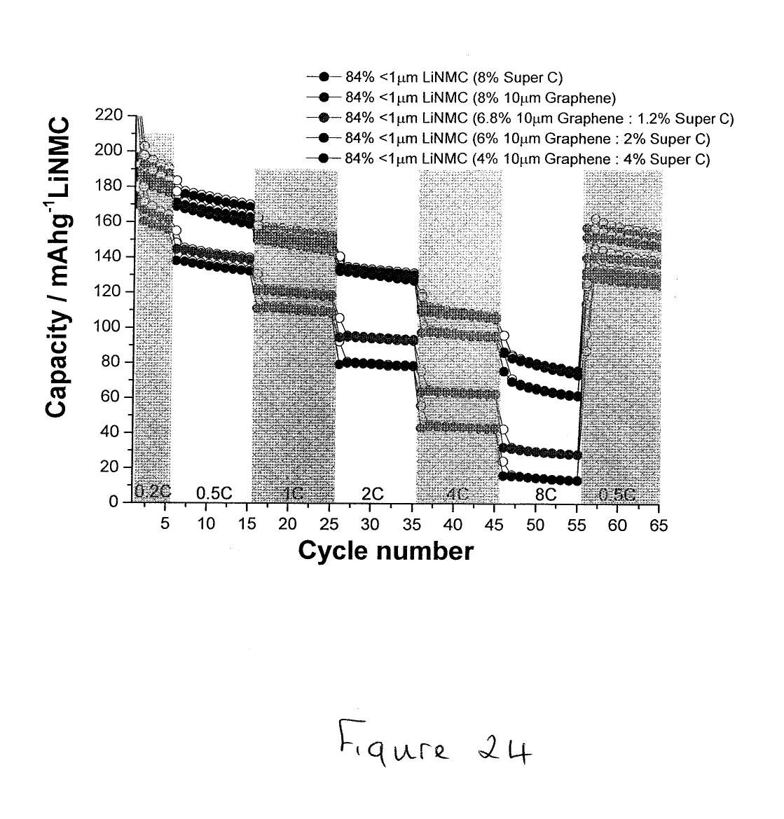

FIGS. 9 to 19 and 21 to 24: Cyclability plots showing the rate capability of LiNMC cathode compositions with different weight ratios of Super C carbon black and/or graphene material at various charge rates (filled symbols represent the charge capacity and unfilled symbols represent the discharge capacity); and

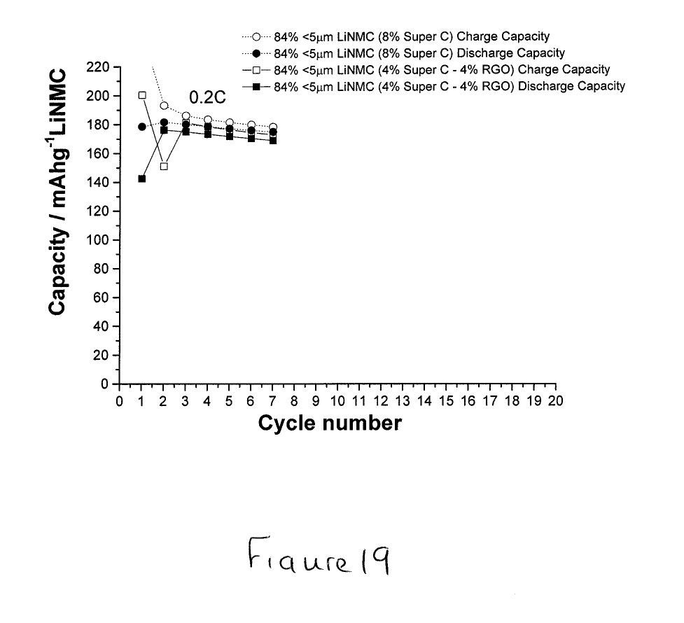

FIG. 20: XRD pattern of LiNMC prepared by a sol-gel technique.

### EXAMPLE 1

### Experimental

The resorcinol-formaldehyde gel technique [K M Shaju et al, Adv. Mater., 2006, 18, 2330] for synthesising the active material LiNi_{1/3}Mn_{1/3}Co_{1/3}O₂ (LiNMC) was carried out by mixing resorcinol, formaldehyde and water until all of the solid components had dissolved. A stoichiometric ratio of lithium acetate dihydrate, nickel (II) acetate tetrahydrate, manganese (II) acetate tetrahydrate and cobalt (II) acetate tetrahydrate was dissolved in water and then added to the resorcinol-formaldehyde mixture. The resulting solution contained a 5 mol % excess of Li. The mixture was heated at 60° C. until viscous, then at 90° C. for 24 h, followed by calcination at 950° C. to form the macroporous LiNMC.

LiNMC (84 wt %), kynarflex 2801 binder (8 wt %) and 8 wt % of a mixture of CNERGY Super C 65 carbon black (TIMCAL) and a graphene material prepared by electrochemical exfoliation were mixed in about 10 mL tetrahydrofuran to form a slurry. The graphene material had a flake dimension of 5 μm, a thickness of graphene sheets of 100-200 nm estimated from SEM and a surface oxygen content of 3 to 5% measured by XPS. The slurry was stirred for 4 hours and then sonicated for one hour. The mixture was then cast on an aluminium current collector (30 μm thickness) and dried at 90° C. under vacuum overnight. 12 mm electrodes were cut, weighed and stored inside a glovebox.

Four different ratios of Super C carbon black and graphene material were tested:

100% Super C carbon black;

15% Super C carbon black—85% graphene;

25% Super C carbon black—75% graphene; and

50% Super C carbon black—50% graphene.

### Preparation of Cells

Coin-type electrochemical cells were prepared using each of the LiNMC electrodes as a cathode, a glass fibre separator impregnated with commercial electrolyte LP30 (1M lithium hexafluorophosphate in 1:1 w/w ethylene carbonate and dimethyl carbonate) and a lithium metal anode. The cells were assembled under an argon atmosphere and tested using a battery cycler (Maccor).

The coin-type electrochemical cells were charged and discharged between 4.6 V and 2.5 V at different rates (0.2 C; 0.5 C; 1 C; 2 C; 4 C; 8 C; and 0.5 C) with 1 C defined as 200 mA.g⁻¹. One C is derived from the capacity obtained at low current.

### Results and Discussion

FIG. 1 shows charge and discharge curves for each LiNMC cathode tested three times to assess the reproducibility of the data. There is little hysteresis which means that the intercalation is reversible. The LiNMC cathode demonstrates good electrochemical performance. The capacities are significantly higher than lithium cobalt oxide for the range of rates studied. The capacity decreases for higher rates due to faster lithium-ion intercalation kinetics.

The results in FIG. 1 show that the best performing LiNMC cathode was the one prepared with 50% Super C carbon black and 50% graphene with a capacity of 70 mAh.g⁻¹ at 8 C. The lowest capacity of 9 mAh.g⁻¹ was attributable to the cathode prepared with only Super C carbon black. This supports a conclusion that the addition of graphene to Super C carbon black improves the electronic conductivity in the LiNMC cathode and its rate capability.

Scanning electron microscopy and energy-dispersive X-ray spectroscopy (EDS) were employed to correlate the morphology with the electrochemistry of the different cathodes. The SEM images in FIG. 2 show different dispersions of active material with different conductive additives. The LiNMC particles pack fairly well between the small particles of Super C carbon black but not very well around the large graphene flakes. It is possible to clearly differentiate active material, Super C carbon black and graphene in the images. This would indicate a worse electrochemistry due to less connectivity of the particles. However that is not what is observed.

The EDS elemental mapping of carbon from the 100% Super C carbon black (FIG. 3) shows the cathode with the most homogeneous distribution of active material. This is counter intuitive since the electrode displayed the lowest electrochemical performance at high rates. The addition of graphene to carbon black creates an aggregation of carbon material and structural islands of active material. This creates routes of high conductivity in the electrodes. The SEM images in FIG. 3 match the EDS analysis.

The elemental mapping for fluorine from the binder (FIG. 5) shows a more homogeneous casting for the four different ratios of Super C carbon black and graphene. The mapping for manganese from the active material (FIG. 4) follows in-between the other two elemental mappings.

Combining the imaging and electrochemistry data, it appears that for the optimum cathode, there may be a compromise between the ability of Super C carbon black to disperse the active material leading to a casting with higher connectivity and the high electrical conductivity (but poor packing ability) of graphene. Hence the 1:1 cathode has better charge/discharge capacity at higher rates.

### EXAMPLE 2

A casting of 100% 1 μm flake graphene obtained by electrochemical exfoliation was prepared and tested in the same conditions as those referred to above.

From the rate capability data (FIG. 6) it can be seen that the performance of the 100% 1 μm graphene compares with that of 100% Super C carbon black which is in keeping with what was observed for different connectivity and electric conductivity. The smaller graphene flake (1 μm) casting has better packing ability than the larger graphene flake (5 μm) and has better electric conductivity properties than Super C carbon black. That explains the intermediate result of the 100% 1 μm graphene electrode in the charge/discharge experiment.

The imaging data for the 1 μm graphene (FIG. 7) is in good agreement with what was observed for the larger 5 μm graphene flakes and Super C carbon black castings (see FIG. 8). It correlates the structure of the cathodes with the different specific capacities obtained and corroborates the idea of different conductivity and connectivity of the different electrodes.

### Conclusions

The use of graphene in combination with Super C carbon black in lithium-ion cells showed promising results with significant improvement of the cathode capacity. The 1:1 w/w graphene: Super C carbon black gave the best performance.

### EXAMPLE 3

### Experimental

A hydroxide co-precipitation technique was used to synthesise the active material LiNi_{1/3}Mn_{1/3}Co_{1/3}O₂ (LiNMC). There are a wide range of conditions that can dramatically affect inter alia the particle size, morphology and electrochemical properties which include calcination temperatures and times, pH of solution before and during nitrate addition, rate of addition of nitrates, stirring speed of solution and the addition of chelation or pH buffering agents (see F. Zhou, X. Zhao, J. Jiang and J. R. Dahn, Electrochem. Solid-State Lett., 2009, 12, A81 and M.-H. Lee, Y.-J. Kang, S.-T. Myung, Y.-K. Sun, Electrochimica Acta, 2004, 50, 939). The mixed transition metal hydroxide (Ni_{1/3}Co1/3Mn_{1/3})(OH)₂ was formed as a precursor by adding a solution of a stoichiometric ratio of the appropriate metal nitrates dropwise at a rate of 1 ml/min or 1.5 ml/min into a lithium hydroxide solution stirred at 800rpm or 500rpm to produce <5 μm and >50 μm particles respectively. The precursor was filtered, washed and dried and then mixed with a stoichiometric amount (1.05 Li in the starting composition) of lithium hydroxide hydrate (LiOH.H₂O). This mixture was then ground and the resulting powder pressed into pellets. The pellets were initially heated to 480° C. for 4 h. The product was cooled and reground, repressed into pellets and heated at 950° C. for 24 h. This was followed by cooling to room temperature.

XRD was used to establish stoichiometry and SEM was used to establish particle size. Samples of LiNMC having a particle size of >50 μm and <5 μm were prepared for comparison with a “standard” sample of LiNMC having a particle size of 2.5 μm. A sample of electrochemically prepared graphene material having a particle size of <50 μm consisting of 10 to 50 μm-sized sheets was used. Reduced graphene oxide (RGO) having a particle size >50 μm was prepared according to the Hummers method.

Cathodes were fabricated by casting the active material with Super C carbon black and/or graphene material on a current collector as described in Example 1. FIGS. 9 to 19 are cyclability plots showing the rate capability of LiNMC cathode compositions with different weight ratios of Super C carbon black and/or graphene material at various charge rates. The characteristics of the LiNMC cathode compositions are indicated in the Figure legend.

Results and Discussion Various conclusions can be drawn from the results shown in FIGS. 9 to 19:

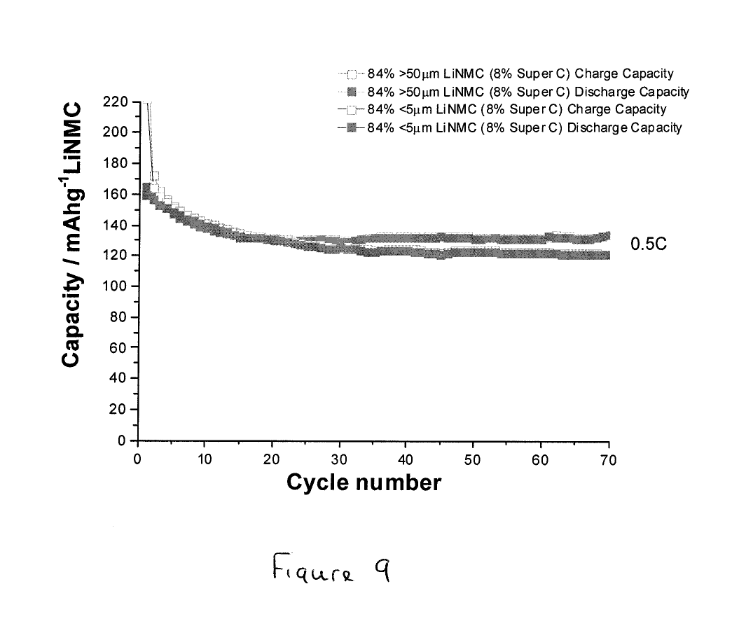

(1) 76% >50μm LiNMC with Super C carbon black shows good performance for testing with graphenic materials compared with the standard (FIG. 10)

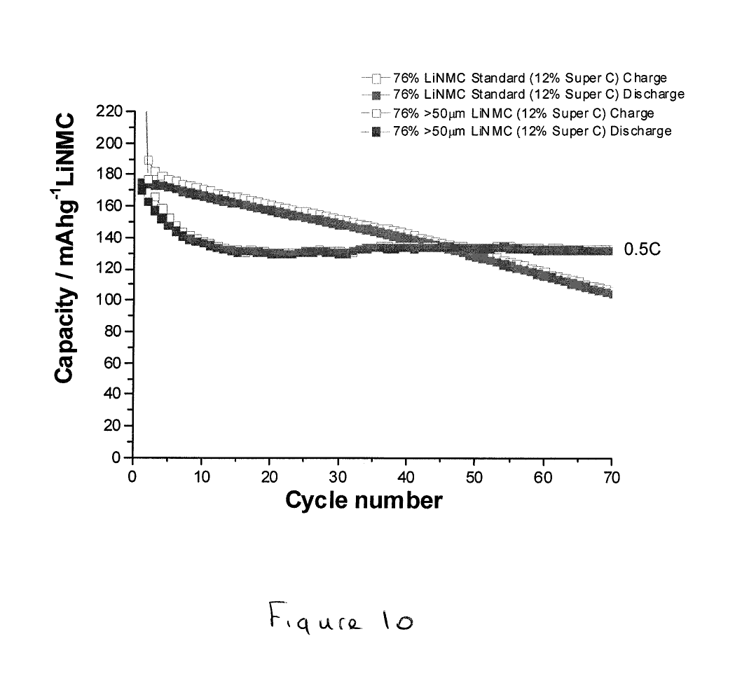

(2) The electrochemical properties of <5 μm LiNMC with Super C carbon black and the standard are comparable at low current rates of 0.2 C (FIG. 11)

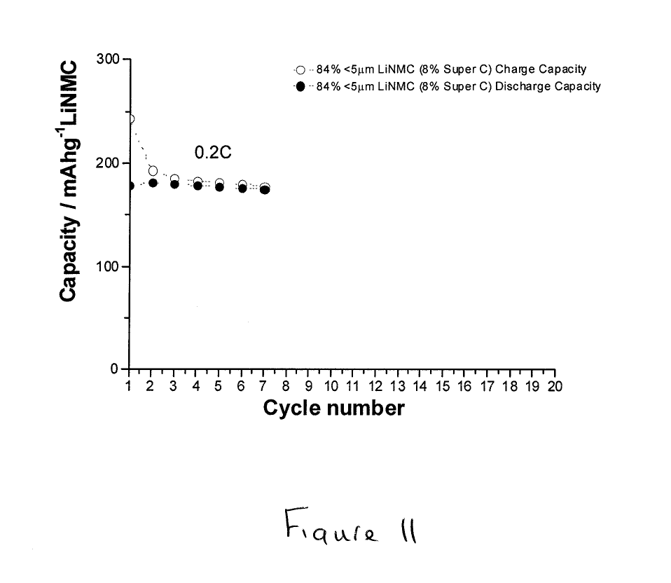

(3) The performance of 76%>50 μm LiNMC with Super C carbon black is about the same as 84%>50 μm LiNMC with Super C carbon black but better than 92%>50 μm LiNMC with Super C carbon black (FIG. 12)

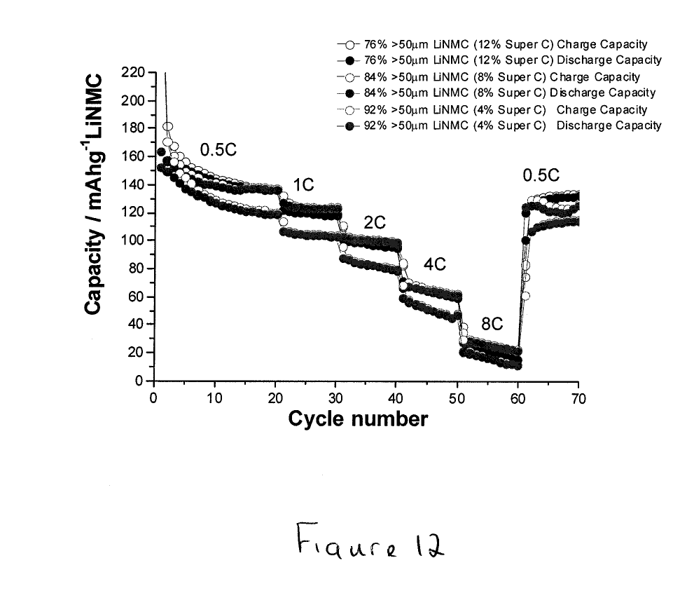

(4) 84%>50 μm LiNMC with Super C carbon has good capacity retention and acceptable rate capability (FIG. 13)

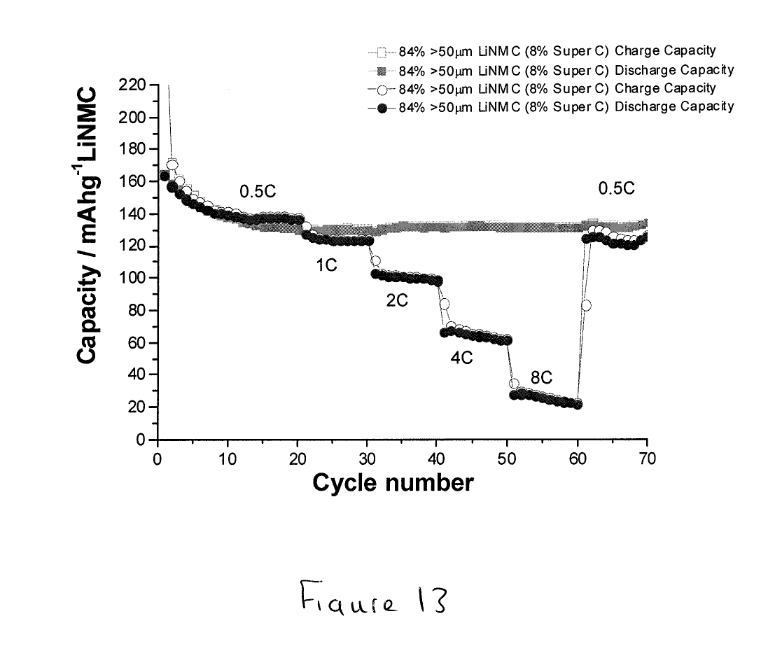

(5) 84%<5 μm LiNMC with Super C carbon has good capacity retention and acceptable rate capability (FIG. 14)

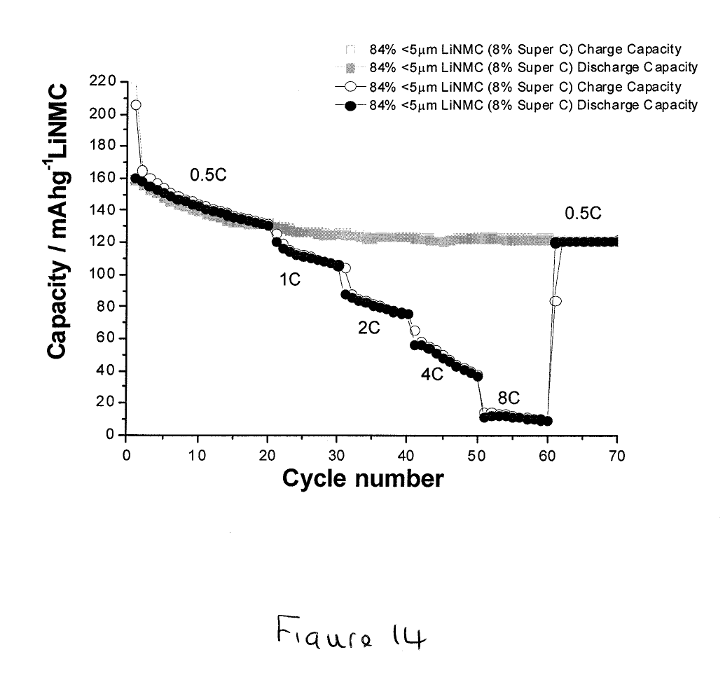

(6) 84%>50 μm LiNMC with Super C carbon performs similarly to 84%<5 μm LiNMC with Super C carbon at 0.5 C (FIG. 15)

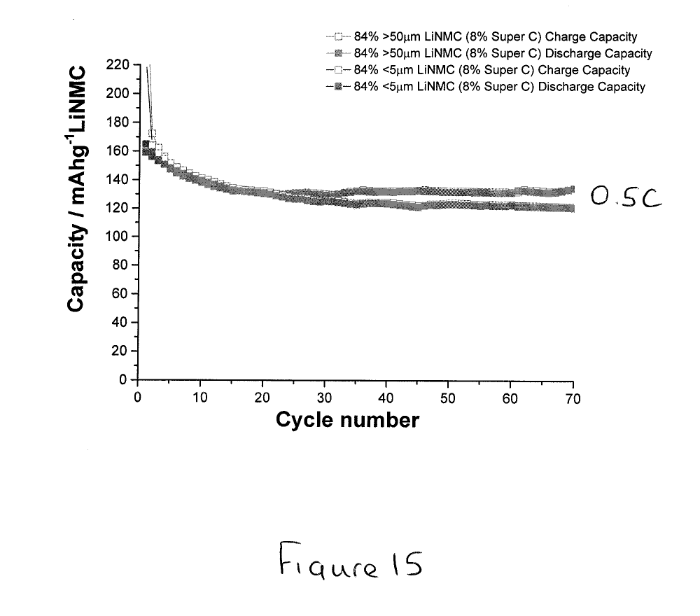

(7) in comparison with the performance of cathode compositions containing no graphene material, 84%<5 μm LiNMC with 8%<50 μm graphene showed worse performance and 84%<5 μm LiNMC with 8% RGO showed no intercalation at all (FIG. 16)

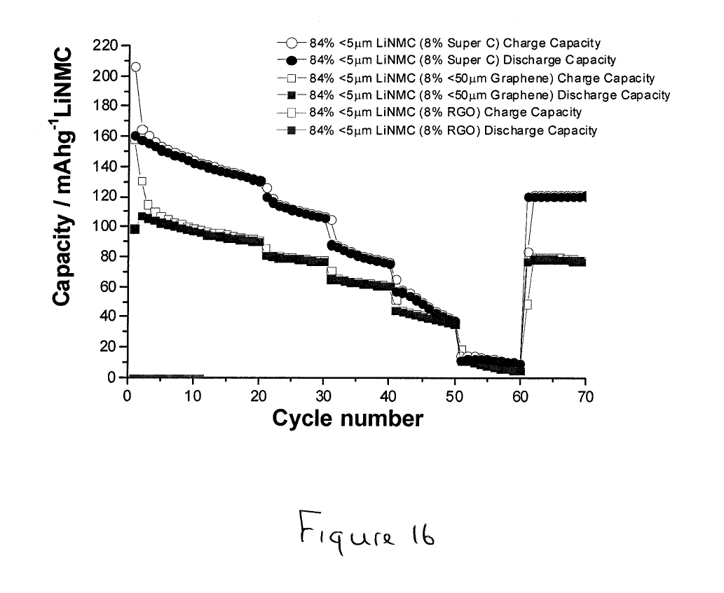

(8) in comparison with the performance of cathode compositions containing no graphene material, 84%>50 μm LiNMC with 4% Super C and 4%<50 μm graphene showed no significant difference but slightly better recovery and 84%>50 μm LiNMC with 4% Super C and 4% RGO showed worse capacity but similar recovery (FIG. 17)

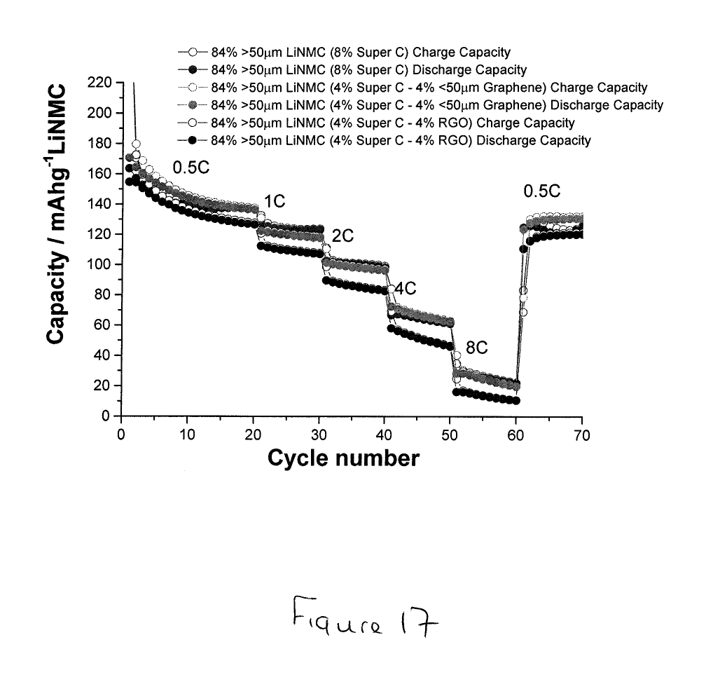

(9) in comparison with the performance of cathode compositions containing no graphene material, 84%<5 μm LiNMC with 4% Super C and 4% RGO showed considerably greater capacity but a similar profile (FIG. 18)

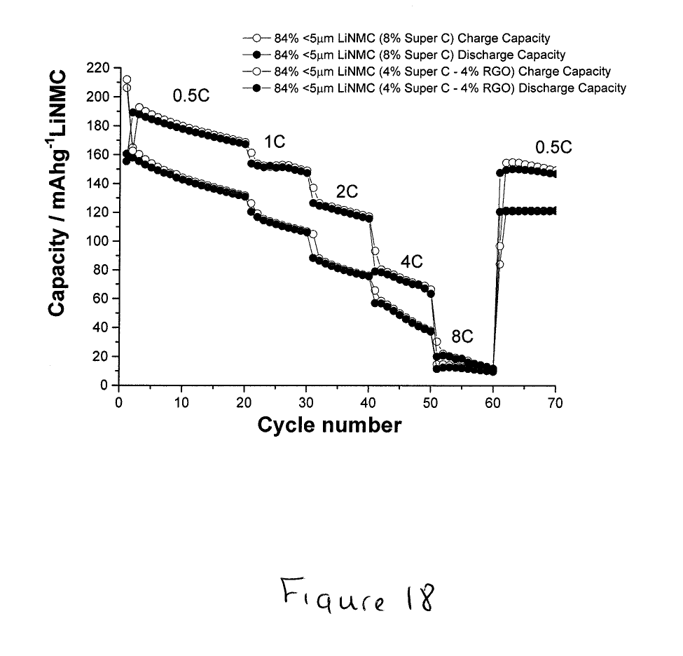

(10) 84%<5 μm LiNMC with 4% Super C and 4% RGO at 0.2 C showed similar capacity to 8% Super C and to 4% Super C-4% RGO at 0.5 C rate (FIG. 19).

### EXAMPLE 4

Experimental

The versatile resorcinol-formaldehyde sol-gel technique (K M Shaju et al, [supra]) was used to synthesise the active material LiNi_{1/3}Mn_{1/3}Co_{1/3}O₂ (LiNMC). By controlling the R-F matrix which can be achieved by altering conditions such as pH, gelation time, the quantities and ratios of resorcinol and formaldehyde (see A. M. ElKhatat and S. A. Al-Muhtaseb, Adv. Mater., 2011, 23, 2887), it is possible to control the particle size of the LiNi_{1/3}Mn_{1/3}CO_{1/3}O₂.

0.1 mol resorcinol, 0.15 mol formaldehyde and 0.001 mol lithium carbonate were mixed in distilled water until the solid components had dissolved. Quantities of lithium acetate dihydrate, nickel (II) acetate tetrahydrate, manganese (II) acetate tetrahydrate and cobalt (II) acetate tetrahydrate in a stoichiometric ratio corresponding to 0.02 mol of LiNi_{1/3}Mn_{1/3}Co_{1/3}O₂ were dissolved in water and then added to the resorcinol formaldehyde mixture. The resulting solution was heated to 60° C. until polymerisation of the resorcinol and formaldehyde was initiated and then cooled to room temperature and aged for 2 h to form the resorcinol-formaldehyde gel. This gel was heated at 90° C. overnight (to evaporate the bulk of the water), then at 950° C. for 14 hours, before being cooled to room temperature to form macroporous lithium nickel manganese cobalt oxide.

XRD was used to establish stoichiometry (see FIG. 20) and SEM was used to establish particle size. A sample of LiNMC having a particle size of <1 μm was prepared for comparison with a “standard” sample of LiNMC having a particle size of 2.5 μm. Samples of graphene having a particle size of 10 μm and 5 μm were used.

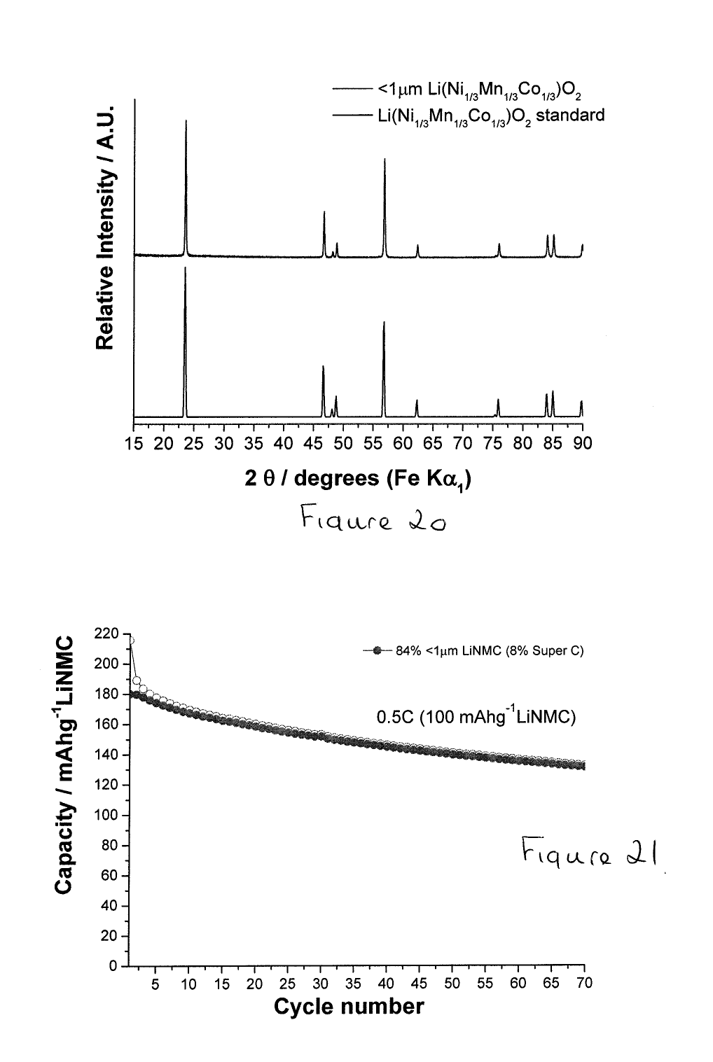

Cathodes were fabricated by casting the active material with Super C carbon black and/or graphene material on a current collector as described in Example 1. FIGS. 21 to 24 are cyclability plots showing the rate capability of LiNMC cathode compositions with different weight ratios of Super C carbon black and/or graphene material at various charge rates. The characteristics of the LiNMC cathode compositions are indicated in the Figure legend.

### Results and Discussion

The performance shown in FIGS. 21 to 24 was comparable with or exceeded a LiNMC composition prepared according to K C Jiang et al, PCCP, 2012, 2934 (see Table below). The performance of 84%<1 μm LiNMC with 5 μm graphene (2%) and Super C carbon black (6%) showed a 20% improvement in capacity at 8 C (1600 mAg⁻¹LiNMC).

| Cathode | Literature | | | | <1 μm | | | | |
|---|---|---|---|---|---|---|---|---|---|
| Material | Li(Ni_{1/3}Mn_{1/3}Co_{1/3})O₂ | | | | Li(Ni_{1/3}Mn_{1/3}Co_{1/3})O₂ | | | | |
| Synthetic | Sol-gel | | | | Sol-gel | | | | |
| Route | | | | | | | | | |
| Particle size | 1 to 2 μm | | | | <1 μm | | | | |
| Wt % LiNMC | 80 | | | | 84 | | | | |
| Wt % Carbon | 5 | | | | 6 | | | | |
| black | | | | | | | | | |
| Graphenic | 5 | | | | 2 | | | | |
| material, wt % | | | | | | | | | |
| Polymeric | 10 | | | | 8 | | | | |
| binder, wt % | | | | | | | | | |
| Potential | 2.5-4.3 | | | | 2.5-4.6 | | | | |
| Range | | | | | | | | | |
| Discharge | 155 mAhg⁻¹ | 145 mAhg⁻¹ | 130 mAhg⁻¹ | 110 mAhg⁻¹ | 166 mAhg⁻¹ | 153 mAhg⁻¹ | 139 mAhg⁻¹ | 119 mAhg⁻¹ | 107 mAhg⁻¹ |
| capacity | at | at | at | at | at | at | at | at | at |
| | 85 mA g⁻¹ | 170 mA g⁻¹ | 510 mA g⁻¹ | 1020 mA g⁻¹ | 100 mA g⁻¹ | 200 mA g⁻¹ | 400 mA g⁻¹ | 800 mA g⁻¹ | 1600 mA g⁻¹ |

| | |
|---|---|
| Reference | K. C. Jiang, et al., PCCP., 2012, 2934 |

1. A protein comprising:
(i) a first and a second copy of hepatitis B core antigen (HBcAg) in tandem, in which one or both of the copies of HBcAg comprises, in the e1 loop, influenza virus A surface polypeptide M2 or an immunogenic fragment thereof flanked on one or both sides by a linker that joins the polypeptide or fragment to HBcAg sequence
(ii) a first and a second copy of HBcAg in tandem, in which one or both of the copies of HBcAg comprises, in the e1 loop, influenza virus A surface polypeptide M2 or an immunogenic fragment thereof flanked on one or both sides by a linker that loins the polypeptide or fragment to HBcAg sequence, wherein the cysteine amino acid at position 17 and/or 19 of the influenza virus A surface polypeptide M2 or the immunogenic fragment thereof is deleted or substituted with an alternative amino acid; or
(iii) a first and a second copy of HBcAg in tandem, in which one or both of the copies of HBcAg comprises influenza virus A surface polypeptide M2 or an immunogenic fragment thereof in the e1 loop and the cysteine amino acid at position 17 and/or 19 of the influenza virus A surface polypeptide M2 or the immunogenic fragment thereof is deleted or substituted with an alternative amino acid.

2-3. (canceled)

4. The protein according to claim 1, wherein:
none copy of HBcAg comprises the influenza virus A surface polypeptide M2 or immunogenic fragment thereof in the e1 loop and the other copy of HBcAg comprises another immunogenic polypeptide; and/or
(ii) the protein comprises the following components: [the part of the first copy of HBcAg that is N-terminal to the e1 loop]—[first linker]—[influenza virus A surface polypeptide M2 or immunogenic fragment thereof]—[second linker]—[the part of the first copy of HBcAg that is C-terminal to the e1 loop]—[third linker]—[the part of the second copy of HBcAg that is N-terminal to the e1 loop]—[the other immunogenic polypeptide]—[the part of the second copy of HBcAg that is C-terminal to the e1 loop]; and/or
(iii) the protein comprises the following components: [the part of the first copy of HBcAg that is N-terminal to the e1 loop]—[first linker]—[influenza virus A surface polypeptide M2 or immunogenic fragment thereof]—[second linker]—[the part of the first copy of HBcAg that is C-terminal to the e1 loop]—[third linker]—[the part of the second copy of HBcAg that is N-terminal to the e1 loop]—[fourth linker]—[the other immunogenic polypeptide]—[fifth linker]—[the part of the second copy of HBcAg that is C-terminal to the e1 loop].

5-6. (canceled)

7. The protein according to claim 4, wherein the other immunogenic polypeptide is an influenza virus polypeptide or immunogenic fragment thereof.

8. The protein according to claim 7, wherein the influenza virus polypeptide or immunogenic fragment thereof is hemagglutinin (HA) or an immunogenic fragment thereof, wherein the fragment of HA is optionally the HA stalk region.

9. The protein according to claim 1, wherein one copy of HBcAg comprises the influenza virus A surface polypeptide M2 or immunogenic fragment thereof in the e1 loop and the other copy of HBcAg comprises, in the e1 loop, a sequence of less than 20 amino acids.

10. The protein according to claim 9, wherein:
(i) the second copy of HBcAg comprises, in the e1 loop, a Lysine (K) residue flanked on each side by a linker sequence comprising Glycine and Serine residues; and/or
(ii) the protein comprises the following components: [the part of the first copy of HBcAg that is N-terminal to the e1 loop]—[first linker]—[influenza virus A surface polypeptide M2 or immunogenic fragment thereof]—[second linker]—[the part of the first copy of HBcAg that is C-terminal to the e1 loop]—[third linker]—[the part of the second copy of HBcAg that is N-terminal to the e1 loop]—[fourth linker]—[Lysine (K) residue]—[fifth linker]—[the part of the second copy of HBcAg that is C-terminal to the e1 loop]; and/or
(iii) the second copy of HBcAg comprises the sequence GSGSGGGKGGGSGS (SEQ ID NO: 21) in the e1 loop.

11-12. (canceled)

13. The protein according to claim 1, wherein the alternative amino acid at position 17 and/or 19 of the influenza virus A surface polypeptide M2 or the immunogenic fragment thereof is serine.

14. The protein according to claim 1, wherein there is more than one copy of the influenza virus A surface polypeptide M2 or immunogenic fragment thereof in the or each e1 loop.

15. The protein according to claim 14, wherein:
(i) there are from 2 to 5 copies of the influenza virus A surface polypeptide M2 or immunogenic fragment thereof in the or each e1 loop; or
(ii) there are 3 copies of the influenza virus A surface polypeptide M2 or immunogenic fragment thereof in the or each e1 loop.

16. (canceled)

17. The protein according to claim 14, wherein there is a linker between each copy of influenza virus A surface polypeptide M2 or immunogenic fragment thereof.

18. The protein according to claim 1, wherein:
(i) the immunogenic fragment of influenza virus A surface polypeptide M2 is the influenza virus A surface polypeptide M2 ectodomain (M2e)
(ii) the immunogenic fragment of influenza virus A surface polypeptide M2 is the influenza virus A surface polypeptide M2 ectodomain (M2e), wherein the or each copy of M2e in the or each e1 loop is the universal M2e consensus sequence or the universal M2e consensus sequence with up to 6 amino acid substitutions, additions or deletions; or
(iii) the immunogenic fragment of influenza virus A surface polypeptide M2 is the influenza virus A surface polypeptide M2 ectodomain (M2e), wherein there are three copies of M2e in the or each e1 loop and the first copy is the universal M2e consensus sequence, the second copy is a common variant found in H3N2 or H7H7 and the third copy is a common variant found in H5N1.

19-20. (canceled)

21. The protein according to claim 1, wherein:
(i) the tandem copies of HBcAg are joined by a linker; and/or
(ii) the or each linker (a) is at least 1.5 nm in length; and/or (b) comprises one or multiple copies of the sequence GlynSer (GnS) wherein n is from 2 to 8.

22. (canceled)

23. The protein according to claim 21(ii), wherein the or each linker is GGGGSGGGGSGGGGS (SEQ ID NO: 5).

24. A protein comprising a first and a second copy of hepatitis B core antigen (HBcAg) in tandem, in which the first copy of HBcAg comprises, in the e1 loop, influenza virus hemagglutinin (HA) or an immunogenic fragment thereof, wherein the fragment of HA is optionally the HA stalk region, and the second copy of HBcAg comprises, in the e1 loop, a sequence of less than 20 amino acids.

25. The protein according to claim 24, wherein:
(i) (a) the fragment of HA is from influenza H3N2 virus hemagglutinin HA2 protein domain; and/or
(b) the second copy of HBcAg comprises, in the e1 loop, a Lysine (K) residue flanked on each side by a linker sequence comprising Glycine and Serine residues; and/or
(ii) the protein comprises the following components: [the part of the first copy of HBcAg that is N-terminal to the e1 loop]—[hemagglutinin (HA) or an immunogenic fragment thereof]—[the part of the first copy of HBcAg that is C-terminal to the e1 loop]—[first linker]—[the part of the second copy of HBcAg that is N-terminal to the e1 loop]—[second linker]—[Lysine (K) residue]—[third linker]—[the part of the second copy of HBcAg that is C-terminal to the e1 loop]; and/or
(iii) the second copy of HBcAg comprises the sequence GSGSGGGKGGGSGS (SEQ ID NO: 21) in the e1 loop.

26-27. (canceled)

28. A particle comprising multiple copies of one or more proteins as claimed in claim 1.

29-33. (canceled)

34. A pharmaceutical composition or vaccine comprising a protein as claimed in claim 1 and a pharmaceutically acceptable carrier or diluent.

35-37. (canceled)

38. The pharmaceutical composition or vaccine according to claim 34, further comprising an adjuvant.

39. A method of inducing an immune response against influenza in a subject or a method of vaccinating a human or animal subject against influenza, which method comprises administering to the subject a protein as claimed in claim 1.

40. (canceled)

41. The method according to claim 39, wherein administration is in combination with an adjuvant.

42-45. (canceled)
